(19) United States
(12) Patent Application Publication
(10) Pub. No.: US 2025/0272541 A1
(43) Pub. Date: Aug. 28, 2025

(54) CROSS TASK LARGE LANGUAGE MODEL FINE-TUNING

(71) Applicant: Microsoft Technology Licensing, LLC, Redmond, WA (US)

(72) Inventors: Ji YAN, San Jose, CA (US); Peide ZHONG, San Jose, CA (US); Xilun CHEN, Sunnyvale, CA (US); Farhan R. TODDYWALA, Jersey City, NJ (US); Guangming LU, Sunnyvale, CA (US)

(21) Appl. No.: 18/585,396

(22) Filed: Feb. 23, 2024

(51) Int. Cl. G06N 3/0455

(52) U.S. Cl. CPC G06N 3/0455

(57) ABSTRACT

Aspects of the disclosure include an architecture for cross task large language model fine-tuning based on a shared context and methods of using the same. An exemplary method includes receiving a pre-trained large language model and receiving a set of fine-tuning tasks for the pre-trained large language model. The set of fine-tuning tasks includes at least a first fine-tuning task and a second fine-tuning task. The method includes generating, from the set of fine-tuning tasks, a first task combination including a subset of the set of fine-tuning tasks, identifying a shared subspace within the subset of the set of fine-tuning tasks, and responsive to identifying the shared subspace, fine-tuning the pre-trained large language model jointly over the first task combination.

### INTRODUCTION

The subject disclosure relates to the use of large language models for knowledge extraction, and particularly to leveraging cross task large language model (LLM) fine-tuning for knowledge extraction and linking based on a shared context.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a cross task large language model (LLM) fine-tuning system powered by a cross task fine-tuning trainer in accordance with one or more embodiments;

FIG. 2 depicts a block diagram of the cross task fine-tuning trainer of FIG. 1 in accordance with one or more embodiments;

FIG. 3 depicts a block diagram of a computer system according to one or more embodiments;

FIG. 4 depicts a flowchart of a method in accordance with one or more embodiments;

FIG. 5 depicts an example transformer-based architecture for a large language model in accordance with one or more embodiments; and

FIG. 6 depicts an example parameter space having various shared subspaces in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Large language models (LLMs) have the potential to revolutionize a range of fields spanning from natural language processing (NLP), such as language translation, sentiment analysis, text summarization, question answering, and named entity recognition, information retrieval, such as with enhanced search engines and improved understanding of user queries, text and image generation, such as generative art, and code generation, among others. Large language models are typically trained on large amounts of text data, often containing hundreds of millions if not billions of words. This process is sometimes referred to as pre-training. To handle the large amount of data, the pre-training process is often highly parallelized. Training can take several days or even weeks, depending on the size of the model and the amount of training data involved. Large language models can be trained using backpropagation and gradient descent, with the objective of minimizing a loss function such as cross-entropy loss.

During pre-training, a large language model learns rich and generalized representations of language, capturing syntactic, semantic, and contextual information leveraged from an enormous corpus of training data. Pre-training can involve the prediction of missing words in sentences and/or understanding the relationship(s) between masked words. Once pre-trained, a large language model can be fine-tuned for specific downstream tasks, such as for reading different types of content (e.g., resumes, social media profiles, etc.) and/or extracting different types of entities (e.g., skills, titles, companies, etc.) from that content. For example, a large language model might be fine-tuned to identify a skill associated with a person's resume, or from their social-media profile.

Fine-tuning typically involves adapting the pre-trained large language model to labeled task-specific data, allowing a large language model to specialize its knowledge and improve performance on the targeted application(s). Specifically, fine-tuning can involve adding a task-specific head to the model architecture and, if necessary, updating one or more weights of the neural network of the model through backpropagation during the fine-tuning training process. In this manner fine-tuning is distinct from training from scratch, where a model's weights are randomly initialized. In fine-tuning, the weights are already optimized to some extent during the pre-training phase.

The decision of which weights to optimize or update, and which ones to keep frozen, depends on the chosen fine-tuning technique. Full fine-tuning involves optimizing or training all layers of the neural network (that is, all weights can be adjusted). Full fine-tuning is natively the most resource-intensive and time-consuming approach and parameter-efficient approaches for fine-tuning have been developed to mitigate their associated resource challenges. One such approach, known as low rank adaptation (LoRA), has demonstrated effectiveness, even outperforming full fine-tuning in some cases. LoRA involves generating a small, task-specific dataset and training a restricted set of parameters of a pre-trained large language model to perform well on that specific task. Specifically, LoRA is an improved fine-tuning method that focuses on fine-tuning two smaller matrices that approximate the larger weight matrix of the pre-trained large language model, rather than fine-tuning all the weights. These smaller matrices constitute the so-called LoRA adapter (a “fine-tuned adapter”), which can be loaded onto a pre-trained large language model and used for inference.

Unfortunately, even parameter-efficient approaches for fine-tuning, such as LoRA, are natively limited by the fact that such fine-tuning regimes are single-task oriented. Observe that a single pre-trained large language model might be fine-tuned for multiple different tasks. For example, a pre-trained large language model might be fine-tuned to identify a skill associated with a person's resume, and that same pre-trained large language model might be fine-tuned to identify a user's skills from their social media posts. In this scenario, current parameter-efficient fine-tuning architectures will generate two separate fine-tuned models, each with their own subset of fine-tuned weights.

This disclosure introduces an architecture for cross task large language model fine-tuning for knowledge extraction and linking based on a shared context. Rather than individually fine-tuning a pre-trained large language model on various tasks, in some embodiments, a single pre-trained large language model is fine-tuned jointly on two or more tasks when those tasks have a shared subspace. As used herein, a “task” refers to the specific objective(s) that a pre-trained large language model is intended to perform after fine-tuning. Examples of tasks can include, for example, identifying one or more skills of an individual from text within the individual's social media profile, determining whether a potential job candidate is likely to be interested in a particular opening, sentiment analysis, text classification, identifying skills from a resume, named entity recognition, etc. As used herein, fine-tuning a model “jointly” on two or more tasks means that the parameters of the model are updated (e.g., fine-tuned) simultaneously on task-specific labeled datasets for all respective tasks-that is, that the tasks are considered together when updating one or more parameters of the model (via gradient descent or otherwise). As used herein, a “shared subspace” means the specific subset of parameters within a parameter space that are common among the different respective tasks, where the parameter space itself refers to the space of all the learnable parameters of a model, such as, in the case of a neural network, the set of all weights and biases across all layers and neurons. Specifically, while parameter-efficient approaches for fine-tuning such as LoRA attempt to approximate a fine-tuned matrix parameter as a low rank matrix, e.g. X=UV, where X is a fine-tuned matrix parameter in R^{{n×n}}, U is a low-rank matrix of X in R^{{n×r}}, and V is a low-rank matrix of X in R^{{r×n}}, the cross task fine-tuning architecture described herein proposes that a set of tasks T should be fine-tuned jointly when there exists some U₁ and V₁ which are shared low rank matrices among all tasks T. In other words, the cross task fine-tuning architecture described herein defines a shared low rank matrix Xₜ=U₁E{t}V₁+U_{{2,t}}, V_{{2,t}}, where U₁ and V₁ are shared low rank matrices among all tasks, U_{{2,t}}, V_{{2,t}} are task-specific low rank matrices, and E_{{t}} is a task-specific diagonal matrix, where the diagonal entries are sparse.

Powering a pre-trained large language model with cross task fine-tuning as described herein solves a number of somewhat related technical issues with current parameter-efficient approaches for fine-tuning. In particular, by fine-tuning tasks separately, patterns across domains/tasks which might be able to improve generalizations can be missed. Continuing with the previous example, prior parameter-efficient approaches will generate separate fine-tuned models to identify skills associated with a person's resume and to identify a user's skills from their social media posts even though, by inspection, such models should be expected to have at least some shared features (e.g., both models are concerned with identifying a person's skills). This is a missed opportunity and cross task fine-tuning can be leveraged to take advantage of the fact that fine-tuning a model to recognize resume skills may help in recognizing skills in a social media post. Other advantages are possible.

Without wishing to be bound by theory, a set of tasks T that are similar semantically (within, e.g., any desired distance measure in an encoding space), will have low dimensional subspaces with at least some overlap. This overlap in low dimensional subspaces can be leveraged during cross task fine-tuning for better generalization and better data efficiency. Notably, by identifying the shared low dimensional subspaces (shared context) between different tasks and fine-tuning a model accordingly, generalizations can be created that can be used to extract knowledge about the tasks from certain pairings of shared subspace features. In short, a shared context enables the extraction of information from prior pairings so that the shared context can be used to extract knowledge in the future without the need to further train the model or to acquire additional data. In this manner, cross task fine-tuning leverages the identification of shared pairings (e.g., semantic patterns) across different types of tasks as a sort of previously inaccessible annotation data. For example, a first task to identify skills associated with a person's resume and a second task to identify a person's skills from their social media posts can be leveraged together during a single cross-task fine-tuning of a model to take advantage of the fact that both tasks have a shared context (identifying a person's skills from some source).

Advantageously, while there is traditionally a bottleneck when it comes to fine-tuning large language models due to the need for high quality annotated data, the shared context patterns described herein can be used to train jointly across all of the different tasks for fine-tuning a large language model to extract knowledge. The benefits of such an approach include joint training to generate shared context across many different types of tasks, and a reduction in the amount of annotated data required for fine-tuning the pre-trained models.

### Detailed Embodiment

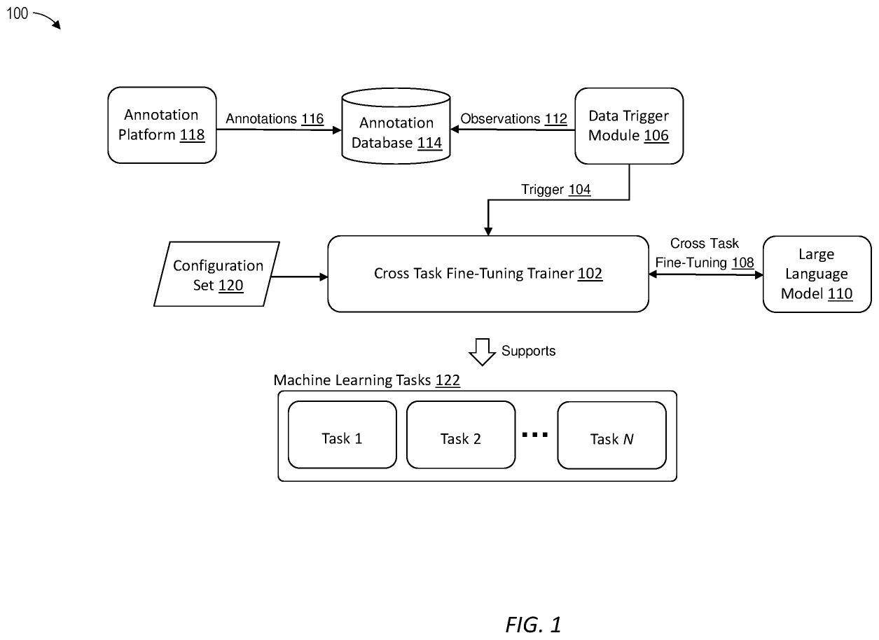

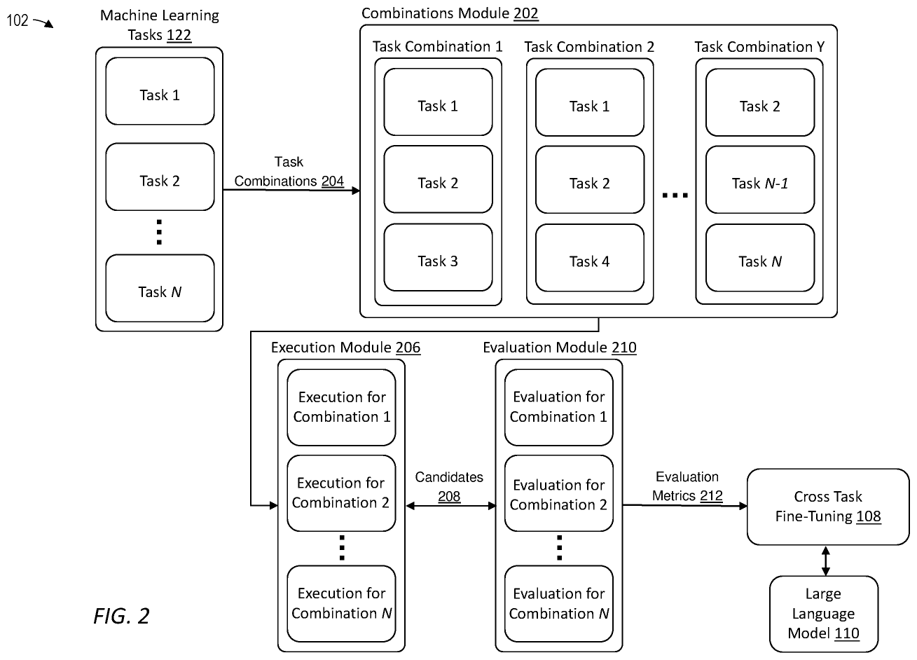

FIG. 1 depicts a block diagram for a cross task large language model (LLM) fine-tuning system 100 powered by a cross task fine-tuning trainer 102 in accordance with one or more embodiments. In some embodiments, the cross task fine-tuning trainer 102 receives a trigger 104 from a data trigger module 106. In some embodiments, the cross task fine-tuning trainer 102 initiates a cross task fine-tuning 108 of a pre-trained large language model 110 responsive to receiving the trigger 104. The trigger 104 is discussed in greater detail below. The cross task fine-tuning 108 of the large language model 110 is discussed with greater detail with respect to FIG. 2.

While not meant to be particularly limited, the large language model 110 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers, although other architectures are within the contemplated scope of this disclosure. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

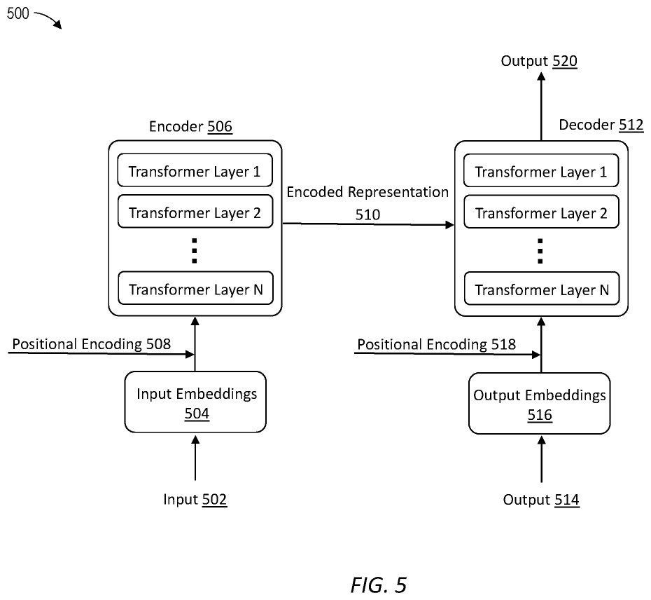

FIG. 5 illustrates an example transformer-based architecture 500 for a large language model (e.g., the large language model 110). As shown in FIG. 5, the transformer-based architecture 500 begins with an input 502. The input 502 denotes an input text provided by a user (or upstream system) and can be represented as a sequence of tokens, individual words or sub-words, from which input embeddings 504 can be generated. The input embeddings 504 represent the tokens within the input 502 as numbers, which can be processed using an encoder 506. In some embodiments, a positional encoding 508 can be generated to encode the position of each token in input 502 as a set of numbers. These numbers can be fed into the encoder 506 with the input embeddings 504, allowing the transformer-based architecture 500 to more effectively understand the order of words in a sentence and to thereby generate grammatically correct and semantically meaningful outputs.

The encoder 506 processes the input embeddings 504 and the positional encoding 508 and generates, for the input 502, an encoded representation 510 that captures the meaning and context of the input 502. To accomplish this, encoder 506 applies a series of self-attention transformer layers (or simply, “transformer layers”), which are a series of hidden states that represent the input 502 at different levels of abstraction. The encoder 506 can include any number of these transformer layers, as desired. The encoded representation 510 is provided to a decoder 512.

The decoder 512 similarly includes a number of transformer layers, as desired, except that the decoder 512 processes an output 514. In most implementations, the output 514 is a right-shifted copy of the input 502, meaning that the decoder 512 can only use the previous words for next-word prediction. In some embodiments, output embeddings 516 can be generated from the output 514 to represent the tokens in the output 514 as numbers, in a similar manner as described with respect to the encoder 506. A positional encoding 518 can be added to the output embeddings 516 to encode the position of each token in output 514 as a set of numbers. The decoder 512 can be trained by minimizing a loss function (also known as an objective function, which quantifies a difference between a predicted output and a known true value) using, for example, gradient descent. Once trained, the transformer-based architecture 500 can be used during a so-called inference phase to generate an output 520, which can be thought of as a next-word probability (that is, how likely is the next word in the sequence to be x, or y, etc.). In some configurations, the transformer-based architecture 500 includes a linear layer and SoftMax layer (omitted for clarify) to transform a raw output from the decoder 512 into the output 514. For example, after the decoder 512 produces a raw output (e.g., output embeddings), the linear layer can map the output embeddings to a higher-dimensional space, thereby transforming the output embeddings into a same original input space as the input 502. The SoftMax function can be used to generate a probability distribution for each output token in the vocabulary, enabling the transformer-based architecture 500 to generate output tokens with probabilities (e.g., the output 520).

Returning to FIG. 1, in some embodiments, the data trigger module 106 makes continuous, periodic, and/or intermittent observations 112 of an annotation database 114. In some embodiments, the data trigger module 106 generates a trigger 104 based on the observations 112. In some embodiments, the trigger 104 includes one or more predefined trigger rules for initiating a cross-task fine-tuning of a model (e.g., initiating a cross task fine-tuning 108 of a pre-trained large language model 110). In some embodiments, the predefined trigger rules are threshold requirements, based on the observations 112, for initiating cross-task fine-tuning. For example, in some embodiments, the data trigger module 106 can be configured to watch the annotation database 114 for data changes (e.g., data annotations 116) and to generate the trigger 104 for the cross task fine-tuning trainer 102 when an amount of new data exceeds a predefined threshold. While not meant to be particularly limited, the predefined trigger rules can include, for example, a data path rule (e.g., trigger when there is an update to a data path that is shared by more than one task), a data freshness rule (e.g., trigger when there is X new data in the past Y days), and/or a data volume rule (e.g., trigger when there is at least X new data records and/or annotations 116).

In some embodiments, the annotation database 114 is populated with annotations 116 via an annotation platform 118. The annotation platform 118 can include both automated and manually sourced annotations 116. For example, annotation platform 118 can include and/or be communicatively coupled to a generative artificial intelligence (GAI) gateway that leverages a large language model(s) for automated data annotation. In another example, the annotation platform 118 can include and/or be communicatively coupled to an interface for receiving human annotations. In some embodiments, the annotation database 114 receives new annotations 116 (whether sourced automatically or manually) continuously, periodically, and/or intermittently.

In some embodiments, the cross task fine-tuning trainer 102 can initiate the cross task fine-tuning 108 of the large language model 110 according to a configuration set 120. The configuration set 120 can include, for example, model configurations (e.g., whether to insert a task-specific head, whether to freeze any particular layer(s), etc.), tokenizer configurations (e.g., vocabulary size, maximum input sequence length, special token identification, etc.), trainer configurations (e.g., batch size, optimizer learning rate, number of training epochs, gradient accumulation, etc.), and/or parameter-efficient fine-tuning configurations (e.g., minimum and/or maximum number of weights to hold, size of adapter matrix as compared to full model, adapter learning rate, etc.).

In some embodiments, the cross task fine-tuning trainer 102 can initiate the cross task fine-tuning 108 of the large language model 110 according to the configuration set 120 responsive to receiving the trigger 104. The large language model 110 can be fine-tuned in this manner to support any number of machine learning tasks 122. In some embodiments, the machine learning tasks 122 includes a first task (as shown, “Task 1”), a second task (as shown, “Task 2”), and an N^{th} task (as shown, “Task N”). The tasks can vary arbitrarily in semantic similarity (again, measured according to any desired distance measure, e.g., in an encoding space). For example, Task 1 might be to fine-tune the large language model 110 to identify a person's skills from their resume, Task 2 might be to fine-tune the large language model 110 to identify job candidates for a person using a collection of their social media posts, and Task N might be to fine-tune the large language model 110 for skill extraction from member profiles of a social network. By inspection, each of these illustrative tasks should be expected to be semantically close within an encoding space (that is, these tasks are semantically similar in that each task is concerned with determining the skills and likely jobs for individuals).

Advantageously, configuring the cross task LLM fine-tuning system 100 in this manner natively reduces engineering friction of large language model finetuning by providing an automated no-code/low-code environment for fine-tuning the large language model 110. Moreover, the data trigger module 106 serves as an intermediary between the annotation platform 118 and the cross task fine-tuning trainer 102, allowing the underlying finetuning pipeline (refer to FIG. 2) to be integrated directly with the annotation pipeline (the annotation platform 118, annotations 116, and annotation database 114) regardless of whether the annotations 116 are automatically or manually sourced. In this manner, the cross task fine-tuning trainer 102 and the large language model 110 can support a variety of machine learning tasks 122. Advantageously, the variety of machine learning tasks 122 are not limited to those examples previously described, as integrating the finetuning pipeline with the annotation pipeline can support a range of downstream platforms, such as, for example, the capability to finetune a large language model for text generation (e.g., for use cases such as resume building), the capability to finetune a large language model for embedding generation (e.g., for use cases such as holistic embeddings), the capability to finetune a large language model for embedding generation (e.g., for use cases such as long text summarization (LTS) segment attribute extraction), and the capability to finetune a large language model for named entity recognition (NER) tagging (e.g., for use cases such skill mention extraction from member profiles).

FIG. 2 depicts a block diagram of the cross task fine-tuning trainer 102 of FIG. 1 in accordance with one or more embodiments. As shown in FIG. 2, the cross task fine-tuning trainer 102 can include a number of internal modules for completing the cross task fine-tuning 108 of the large language model 110. In some embodiments, the cross task fine-tuning trainer 102 includes a combinations module 202. In some embodiments, the combinations module 202 generates one or more unique task combinations 204 of tasks (e.g., Task 1, Task 2, . . . , Task N) from the machine learning tasks 122. In some embodiments, the combinations module 202 generates a set of all possible task combinations. In some embodiments, the combinations module 202 generates a subset of all possible task combinations. The subset of all possible task combinations can be designated (that is, predetermined, such as to generate all 3-tuples, etc.) or random (that is, generate some Y task combinations 204 from all possible combinations). As shown, the combinations module 202 generates a number of task combinations 204 covering all possible 3-tuples (that is, all unique combinations of 3 tasks of the machine learning tasks 122). These include, for example, a task combination 1 (Task 1, Task 2, Task 3), a task combination 2 (Task 1, Task 2, Task 4), and a task combination Y (Task 2, Task N-1, Task N).

In some embodiments, the cross task fine-tuning trainer 102 includes an execution module 206. In some embodiments, the execution module 206 generates candidates 208 for fine-tuning the large language model 110. In some embodiments, a candidate of the candidates 208 is generated for each of the task combinations 204. In some embodiments, a candidate of the candidates 208 is generated for each subset of the tasks T for which a shared low rank matrix Xₜ can be defined, where Xₜ=U₁E{t}V₁+U_{{2,t}}V_{{2,t}}, where U1 and V1 are shared low rank matrices among all tasks T, E{t} is a task-specific diagonal matrix with sparse diagonal entries, and U_{{2,t}} and V_{{2,t}} are task-specific low rank matrices (that is, for all task combinations 204 having a shared subspace as defined previously).

Execution of one of the candidates 208 for fine-tuning the large language model 110 is now discussed with respect to the Task Combination 1, although it should be understood that the described process can be repeated for each of the task combinations 204.

In some embodiments, the candidates 208 includes a candidate fine-tuning of the large language model 110 using the Task Combination 1. In this scenario, Task 1, Task 2, and Task 3 (that is, Task combination 1) are used collectively to fine-tune the large language model 110 (this process can be referred to as cross task fine-tuning to distinguish over single-task fine-tuning). In some embodiments, the large language model 110 is fine-tuned using labeled task-specific training data (not separately indicated) for the tasks of the Task Combination 1. This training data can be split into training, validation, and test sets. In some embodiments, the training set is used for updating model parameters, the validation set is used for tuning hyperparameters, and the test set is used for final evaluation (refer to evaluation module 210 below).

In some embodiments, the execution module 206 initializes the large language model 110 and then adjusts one or more weights of the large language model 110 such that inferences match known true labels (the labeled task-specific training data) of the tasks of the Task Combination 1 within a predetermined accuracy threshold (limited only as desired according to epoch limits and/or other configuration parameters). Weight adjustments can be made using task-specific heads and backpropagation as described previously, although the mechanism for weight adjustments is not meant to be particularly limited. In some embodiments, fine-tuning the large language model 110 over the Task Combination 1 includes setting one or more hyperparameters for the fine-tuning process, including, for example, a learning rate, a batch size, regularization parameters, and/or any parameter-efficient parameters.

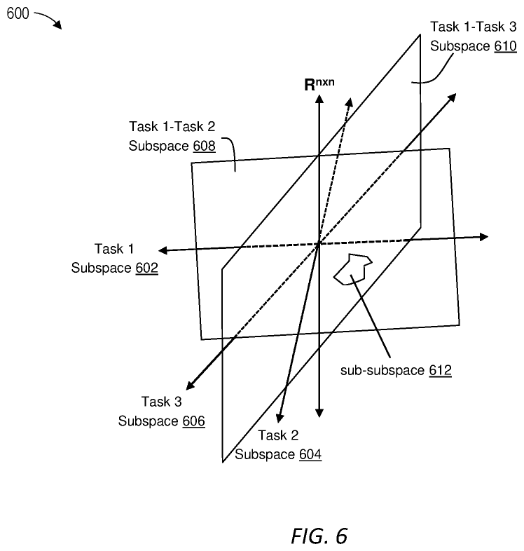

In some embodiments, execution module 206 includes a shared learning portion whereby a shared subspace is identified among the T tasks in U₁ and V₁. An example parameter space 600 having various shared subspaces is shown in FIG. 6 for a set of three tasks in T in accordance with one or more embodiments. As shown in FIG. 6, the parameter space 600 can be represented as an intersection of the respective tasks. The parameter space 600 can include a first subspace 602 (“Task 1” subspace), a second subspace 604 (“Task 2” subspace), and a third subspace 606 (“Task 3” subspace), although the number of tasks is merely illustrative and all such configurations are within the contemplated scope of this disclosure. While not meant to be particularly limited, the first subspace 602 might include a resume data extraction subspace, the second subspace 604 might include a company name recognition subspace, and the third subspace 606 might include a job title recognition subspace.

As further shown in FIG. 6, the intersections between each pair of tasks (e.g., Task 1-Task 2, Task 1-Task 3, and Task 2-Task 3) can themselves be represented as a two-task plane subspace within the parameter space 600. For example, the Task 1-Task 2 subspace 608 depicts the shared subspace between Task 1 and Task 2, and the Task 1-Task 3 subspace 610 depicts the shared subspace between Task 1 and Task 3 (the shared subspace between Task 2 and Task 3 is omitted for clarity).

In some embodiments, the shared subspace is a low rank matrix that is common to all respective tasks. Continuing with the prior example, the shared subspace can be a low rank matrix that is common to each task of the Task Combination 1 (that is, Task 1, Task 2, Task 3). In some embodiments, execution module 206 initializes all U matrices with N(0, 1) entries, all V matrices as 0, and all E matrices as the identity matrix. In some embodiments, sparsity will be enforced for E_{{t}} by taking proximal steps after each gradient update. Gradients can be updated using any desired scheme. In some embodiments, gradients are updated according to a decaying average of partial derivatives using the proximal operator of the L1 norm. This is effectively the same as adding an L1 penalty on the diagonal entries of all E_{{t}} fine-tuned parameters to the objective function. Intuitively, enforcing sparsity in this manner allows each task of the task combinations 204 to select, during training within the execution module 206, which part(s) of the previously identified shared subspace are most relevant to it, which also allows each task to keep its parameters in a lower dimensional subspace, which can further improve generalization. In other words, in some embodiments, the execution module 206 can leverage E_{{t}} to select, for each of the task combinations 204, which portion(s) of the shared subspace is most relevant via sparsity, thereby learning, for each of the task combinations 204, a sort of sub-subspace (a selected portion of the shared subspace) separate from the other tasks within U_{{2,t}} and V_{{2,t}}. To illustrate, an example sub-subspace 612 is depicted in FIG. 6 for Task 1-Task 2 subspace 608. As shown in FIG. 6, sub-subspace 612 represents the portion of the Task 1-Task 2 subspace 608 which has been selected according to E_{{t}} as described previously. Advantageously, when the execution module 206 is configured in this manner and a new task and/or task combination 204 needs to be fine-tuned, the respective matrices for fine-tuning over the task(s) can be initialized to the previously learned U₁ and V₁, enabling a sort of hierarchical pretraining and/or fine-tuning scheme.

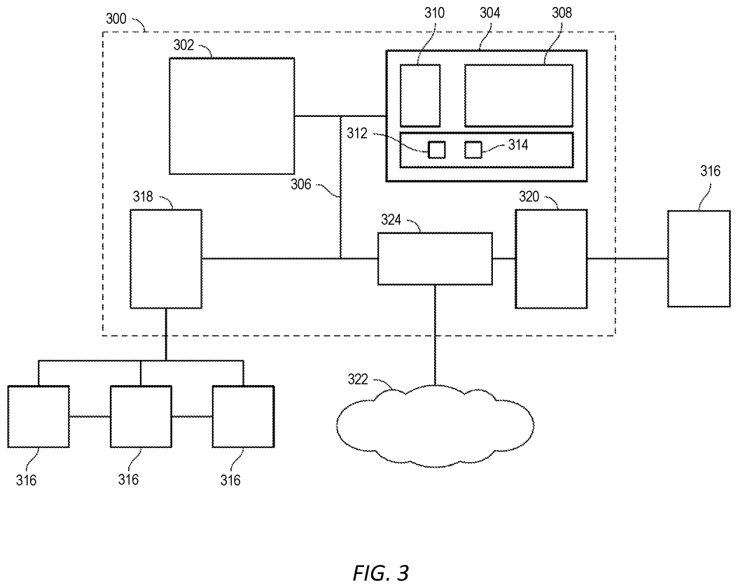

This general process described with respect to the Task combination 1 can then be repeated for any (all) of the Task Combinations 204 and a number of corresponding candidates 208 (fine-tuned versions of the large language model 110 over different subsets of the task combinations 204) are thereby generated. The candidates 208 can be stored locally and/or remotely as desired using, for example, the system memory 304 of FIG. 3. Once stored, the candidates 208 can be retrieved as needed (e.g., for testing against one or more try-runs).

In some embodiments, the candidates 208 are provided to an evaluation model 210 to evaluate each respective candidate's model performance. Model performance can be evaluated using, for example, a validation set to understand how well the respective model generalizes to unseen data. The candidates 208 can be evaluated against any desired and/or predetermined evaluation metrics 212 such as, for example, inference accuracy, F1 score, perplexity, etc. In some embodiments, after each epoch or a predefined number of training iterations of the execution module 206, the respective candidate 208 is evaluated using the evaluation module 210 on a validation set using the defined evaluation metrics 212. In some embodiments, if the validation performance is not satisfactory, one or more hyperparameters can be adjusted and the execution-evaluation process can be repeated. This may involve, for example, changing the learning rate, batch size, and/or other parameters. Alternatively, or in addition, the execution module 206 can be re-run after performing a grid search and/or a random search over a range of hyperparameter values.

In some embodiments, the execution module 206 and the evaluation module 210 are iterated through over a number of different sets of hyperparameters until a configuration is found, for each of the respective candidates 208, that yields a performance (via evaluation metrics 212) on the validation set that achieves a predetermined threshold. In some embodiments, once the performance of the respective candidate 208 reaches the predetermined threshold, the evaluation module 210 is completed a final time for a final evaluation of the candidate 208. In other words, once satisfied with the validation performance, the candidate 208 can be evaluated using a final set of hyperparameters.

In some embodiments, the final evaluation metrics 212 for each of the candidates 208 are compared and the candidate 208 having the highest performance evaluation (measured, e.g., according to any chosen metric or weighted combination of performance metrics, as desired) is selected for the cross task fine-tuning 108 (refer to FIG. 1). In other words, in some embodiments, the weights and/or parameters of the large language model 110 itself (rather than any derivative fine-tuned models generated therefrom) can be adjusted using the most successful combination of task combinations 204 generated during cross task fine-tuning.

FIG. 3 illustrates aspects of an embodiment of a computer system 300 that can perform various aspects of embodiments described herein. In some embodiments, the computer system(s) 300 can implement and/or otherwise be incorporated within or in combination with the cross task LLM fine-tuning system 100 and/or cross task fine-tuning trainer 102 described herein with respect to FIGS. 1 and 2. In some embodiments, a computer system 300 can be implemented server-side. For example, a remote computer system 300 can be configured to receive a trigger 104 and/or configuration set 120 and, responsive to the trigger 104, to initiate a cross task fine-tuning 108 of a large language model 110.

The computer system 300 includes at least one processing device 302, which generally includes one or more processors or processing units for performing a variety of functions, such as, for example, completing any portion of the cross task LLM fine-tuning system 100 (refer to FIG. 1) and/or cross task fine-tuning trainer 102 (refer to FIG. 2), described previously herein. Components of the computer system 300 also include a system memory 304, and a bus 306 that couples various system components including the system memory 304 to the processing device 302. The system memory 304 may include a variety of computer system readable media. Such media can be any available media that is accessible by the processing device 302, and includes both volatile and non-volatile media, and removable and non-removable media. For example, the system memory 304 includes a non-volatile memory 308 such as a hard drive, and may also include a volatile memory 310, such as random access memory (RAM) and/or cache memory. The computer system 300 can further include other removable/non-removable, volatile/non-volatile computer system storage media.

The system memory 304 can include at least one program product having a set (e.g., at least one) of program modules that are configured to carry out functions of the embodiments described herein. For example, the system memory 304 stores various program modules that generally carry out the functions and/or methodologies of embodiments described herein. A module or modules 312, 314 may be included to perform functions related to the block diagrams 100, 110, 300, and 400 as described previously herein. The computer system 300 is not so limited, as other modules may be included depending on the desired functionality of the computer system 300. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 302 can also be configured to communicate with one or more external devices 316 such as, for example, a keyboard, a pointing device, and/or any devices (e.g., a network card, a modem, etc.) that enable the processing device 302 to communicate with one or more other computing devices. Communication with various devices can occur via Input/Output (I/O) interfaces 318 and 320.

The processing device 302 may also communicate with one or more networks 322 such as a local area network (LAN), a general wide area network (WAN), a bus network and/or a public network (e.g., the Internet) via a network adapter 324. In some embodiments, the network adapter 324 is or includes an optical network adaptor for communication over an optical network. It should be understood that although not shown, other hardware and/or software components may be used in conjunction with the computer system 300. Examples include, but are not limited to, microcode, device drivers, redundant processing units, external disk drive arrays, RAID systems, and data archival storage systems, etc.

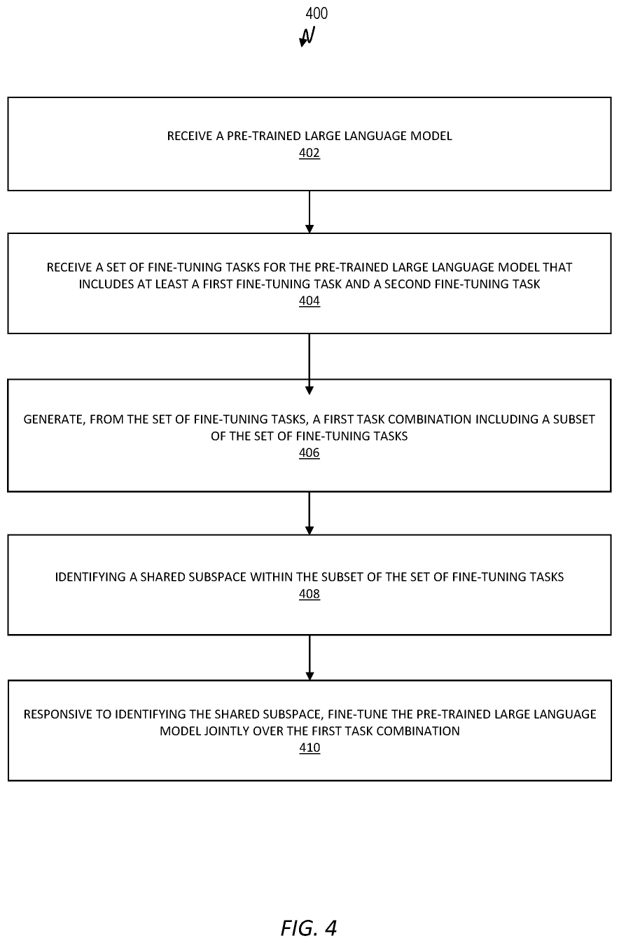

Referring now to FIG. 4, a flowchart 400 for cross task fine-tuning is generally shown according to an embodiment. The flowchart 400 is described with reference to FIGS. 1 to 3 and may include additional steps not depicted in FIG. 4. Although depicted in a particular order, the blocks depicted in FIG. 4 can be, in some embodiments, rearranged, subdivided, and/or combined.

At block 402, the method includes receiving a pre-trained large language model.

At block 404, the method includes receiving a set of fine-tuning tasks for the pre-trained large language model. In some embodiments, the set of fine-tuning tasks includes at least a first fine-tuning task and a second fine-tuning task.

At block 406, the method includes generating, from the set of fine-tuning tasks, a first task combination including a subset of the set of fine-tuning tasks.

At block 408, the method includes identifying a shared subspace within the subset of the set of fine-tuning tasks. In some embodiments, identifying the shared subspace includes identifying a low rank matrix which is common to the subset of the set of fine-tuning tasks of the first task combination.

At block 410, the method includes, responsive to identifying the shared subspace, fine-tuning the pre-trained large language model jointly over the first task combination. In some embodiments, fine-tuning the pre-trained large language model jointly over the first task combination includes enforcing sparsity by taking proximal steps after each gradient update. In some embodiments, sparsity is enforced according to a task-specific diagonal matrix having sparse diagonal entries.

In some embodiments, the method includes generating, from the set of fine-tuning tasks, a plurality of task combinations. In some embodiments, each task combination of the plurality of task combinations includes a unique subset of the set of fine-tuning tasks.

In some embodiments, the method includes generating a candidate fine-tuned model of the pre-trained large language model for each of the plurality of task combinations. In some embodiments, the method includes evaluating an inference performance of each of the candidate fine-tuned models using labeled task-specific data. In some embodiments, the method includes selecting, from the candidate fine-tuned models, a candidate having a highest performance metric. In some embodiments, the method includes updating at least one weight of the pre-trained large language model to match a respective weight of the candidate having the highest performance metric.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein.

In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving a pre-trained large language model;
receiving a set of fine-tuning tasks for the pre-trained large language model, the set of fine-tuning tasks comprising at least a first fine-tuning task and a second fine-tuning task;
generating, from the set of fine-tuning tasks, a first task combination comprising a subset of the set of fine-tuning tasks;
identifying a shared subspace within the subset of the set of fine-tuning tasks; and
responsive to identifying the shared subspace, fine-tuning the pre-trained large language model jointly over the first task combination.

2. The method of claim 1, wherein identifying the shared subspace comprises identifying a low rank matrix which is common to the subset of the set of fine-tuning tasks of the first task combination.

3. The method of claim 1, further comprising generating, from the set of fine-tuning tasks, a plurality of task combinations, wherein each task combination of the plurality of task combinations comprises a unique subset of the set of fine-tuning tasks.

4. The method of claim 3, further comprising generating a candidate fine-tuned model of the pre-trained large language model for each of the plurality of task combinations.

5. The method of claim 4, further comprising evaluating an inference performance of each of the candidate fine-tuned models using labeled task-specific data.

6. The method of claim 5, further comprising selecting, from the candidate fine-tuned models, a candidate having a highest performance metric.

7. The method of claim 6, further comprising updating at least one weight of the pre-trained large language model to match a respective weight of the candidate having the highest performance metric.

8. The method of claim 1, wherein fine-tuning the pre-trained large language model jointly over the first task combination comprises enforcing sparsity by taking proximal steps after each gradient update.

9. The method of claim 8, wherein sparsity is enforced according to a task-specific diagonal matrix having sparse diagonal entries.

10. A system having a memory, computer readable instructions, and one or more processors for executing the computer readable instructions, the computer readable instructions controlling the one or more processors to perform operations comprising:
receiving a pre-trained large language model;
receiving a set of fine-tuning tasks for the pre-trained large language model, the set of fine-tuning tasks comprising at least a first fine-tuning task and a second fine-tuning task;
generating, from the set of fine-tuning tasks, a first task combination comprising a subset of the set of fine-tuning tasks;
identifying a shared subspace within the subset of the set of fine-tuning tasks; and
responsive to identifying the shared subspace, fine-tuning the pre-trained large language model jointly over the first task combination.

11. The system of claim 10, wherein identifying the shared subspace comprises identifying a low rank matrix which is common to the subset of the set of fine-tuning tasks of the first task combination.

12. The system of claim 10, further comprising generating, from the set of fine-tuning tasks, a plurality of task combinations, wherein each task combination of the plurality of task combinations comprises a unique subset of the set of fine-tuning tasks.

13. The system of claim 12, further comprising generating a candidate fine-tuned model of the pre-trained large language model for each of the plurality of task combinations.

14. The system of claim 13, further comprising evaluating an inference performance of each of the candidate fine-tuned models using labeled task-specific data.

15. The system of claim 14, further comprising selecting, from the candidate fine-tuned models, a candidate having a highest performance metric.

16. The system of claim 15, further comprising updating at least one weight of the pre-trained large language model to match a respective weight of the candidate having the highest performance metric.

17. The system of claim 10, wherein fine-tuning the pre-trained large language model jointly over the first task combination comprises enforcing sparsity by taking proximal steps after each gradient update.

18. The system of claim 17, wherein sparsity is enforced according to a task-specific diagonal matrix having sparse diagonal entries.

19. A computer program product comprising a computer readable storage medium having program instructions embodied therewith, the program instructions executable by one or more processors to cause the one or more processors to perform operations comprising:
receiving a pre-trained large language model;
receiving a set of fine-tuning tasks for the pre-trained large language model, the set of fine-tuning tasks comprising at least a first fine-tuning task and a second fine-tuning task;
generating, from the set of fine-tuning tasks, a first task combination comprising a subset of the set of fine-tuning tasks;
identifying a shared subspace within the subset of the set of fine-tuning tasks; and
responsive to identifying the shared subspace, fine-tuning the pre-trained large language model jointly over the first task combination.

20. The computer program product of claim 19, wherein identifying the shared subspace comprises identifying a low rank matrix which is common to the subset of the set of fine-tuning tasks of the first task combination.
